(19) United States
(12) Patent Application Publication
(10) Pub. No.: US 2006/0143327 A1
(43) Pub. Date: Jun. 29, 2006

(54) System for synchronously controlling multiple devices

(75) Inventors: Wei-Ting Hsieh, Tainan City (TW); Chin-Chou Chang, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 11/024,205

(22) Filed: Dec. 28, 2004

(51) Int. Cl. G06F 3/00

(52) U.S. Cl. 710/18

(57) ABSTRACT

The present invention discloses a system for synchronously monitoring and controlling multiple media devices, such as the DVD-RW drive, the music player, the TV tuner, the DVD player, etc. The system includes a user interface in form of a polyhedron like a cube, and one surface of the polyhedron is able to present the operation status of each media device which is coupled to the media center of the system. To demonstrate the operation statuses, the indicator lights with distinguishable colors could be applied. Besides, the way of operation status expression may further include the preview window and the progress bar. With the system, especially the user interface thereof, the user is able to monitor and control a great amount of media devices synchronously and instantly in a convenient and simple way.

### FIELD OF THE INVENTION

The present invention is related to a system for controlling devices, especially for synchronously and instantly controlling and monitoring multiple media devices, such as the DVD/CD burner, the MP3 player, the DVD/VCD player, the DVD recorder, or the TV tuner.

### BACKGROUND OF THE INVENTION

Recently, people are provided with more and more media devices for entertaining or facilitating their life. With these devices, the user could enjoy high quality movies, keep large amount of data, or record favorite TV programs. Each media device may work independently or be controlled by other instrument, such as the computer. For example, the DVD player could play the movies in a DVD without support of other instruments, though a displayer such as a LCD is still required. In the other hand, a DVD-RW drive installed in the computer could also play the content of a DVD with the assistant that computer. A use of audio-visual information presentation is advocacy. The use of visual media can provide dramatic effects. For this reason, audio-visual presentations should be as unencumbered as possible with technology effect. If the presentation is poorly designed, it may lose the audience's attention. The computer system may provide additional tools in both the creation and delivery of an effective presentation.

To manage multiple devices, a computer is usually required, and the devices may constitute a part of the computer. Conventionally, each device is associated with an application, for instance, a burn application for a DVD-RW drive. These applications generally have their own user interfaces individually, that is, an application needs a window in Windows® operation system (Windows®) is a registered trademark of Microsoft Corporation). Hence, quite a few applications would be invoked if plural media devices are in use at the same time. In such a situation, the user has to switch one user interface to another again and again in order to monitoring the operation status of each media device. That makes the management of plural devices quite complex and inconvenient, especially in that situation that there are a great amount of media devices.

Multimedia as it is used for presentation purposes covers a wide range of displays, both audio and visual. There are programs that can provide manipulation of devices. However, there is no graphics program that allows easy and precise manipulation. U.S. Pat. No. 5,933,807 to Fukuzawa shows how a displayed picture can be manipulated by a generated sound signal.

Hence, to manage multiple media devices instantly, a more efficient way should be provided.

### SUMMARY OF THE INVENTION

In view of aforementioned problems, the present therefore discloses a system and a method for synchronously controlling multiple devices. With the system and method, a user could monitor all of the devices that coupled to a media center, such as a computer. Single user interface is provided for the user to manage all devices, and the operation status of each device could be monitored instantly.

According to one purpose of the present invention, a computer-readable storage medium having computer-executable instructions is disclosed. The computer-readable storage medium is able to synchronously monitor and control at least one device by performing the following steps, comprising: detecting the connection status between a media center and the devices; obtaining the operation status of each coupled device, wherein the operation status is updated every predetermined period; generating an object to present the operation status on a user interface, wherein the user interface is displayed on a displayer coupled to the media center; and showing the controlling panel and the content of the selected device on the object of the user interface, wherein the object includes at least two surfaces presenting at least two kinds of information. The way to present the operation status may include distinguishable colors of indicator lights, a progress bar, or a preview window. The user interface may be a virtual rotatable three-dimensional object, such as a polyhedron or a ball, which has a first surface showing every operation status and a second surface showing the controlling panel and the content of the selected device. Besides, the types of the storage medium may include a CD, a DVD, a Blu-ray disc, a floppy disc, a hard disc, or memory.

According to another purpose of the present invention, a system for synchronously controlling multiple devices is disclosed. The system comprises plural devices, a media center for controlling the multiple devices coupled thereto, a user interface generator coupled to the media center for generating a user interface, an object generator coupled to the media center for generating an object on the user interface, wherein a first surface of the object presents an operation status of the devices and the operation status is updated in a predetermined period, a displayer coupled to the media center for showing the user interface, and an input apparatus coupled to the media center for selecting a selected device, wherein a second surface of the object presents a control panel and content of said selected device as the selected device is designated via the input apparatus.

### BRIEF DESCRIPTION OF THE DRAWINGS

FIG. 1 is the computer-readable storage medium according to one embodiment of the present invention.

FIG. 2 is the flow chart showing the controlling process according to one embodiment of the present invention.

FIG. 3 is the system block diagram according to one embodiment of the present invention.

FIG. 4 shows two surfaces of the user interface according to one embodiment of the present invention.

### DETAILED DESCRIPTION OF THE PREFERRED EMBODIMENT

Referring now to the drawings wherein the showings are for the purpose of illustrating the preferred embodiments of the present invention only, and not for the purpose of limiting same.

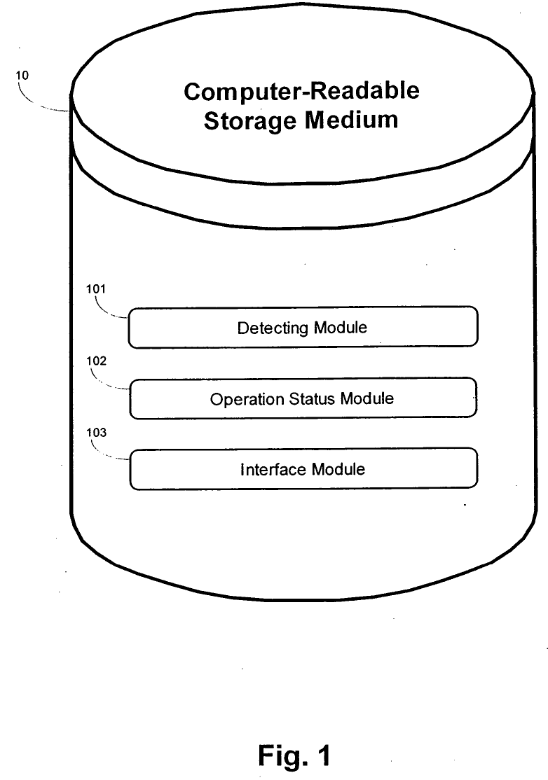

FIG. 1 shows a computer-readable storage medium 10, and the storage medium 10 has the computer-executable instructions for synchronously monitoring and controlling multiple media devices. As presented in the drawings, the storage medium 10 at least includes three modules, which are the detecting module 101, the operation status module 102, and the interface module 103. For those who are skilled in the art, these modules may be computer programs or a list of instructions. Besides, the types of storage medium 10 includes a CD, a DVD, a Blu-ray disc, a floppy disc, a hard disc, memory, or any means with the capability of storing digital data.

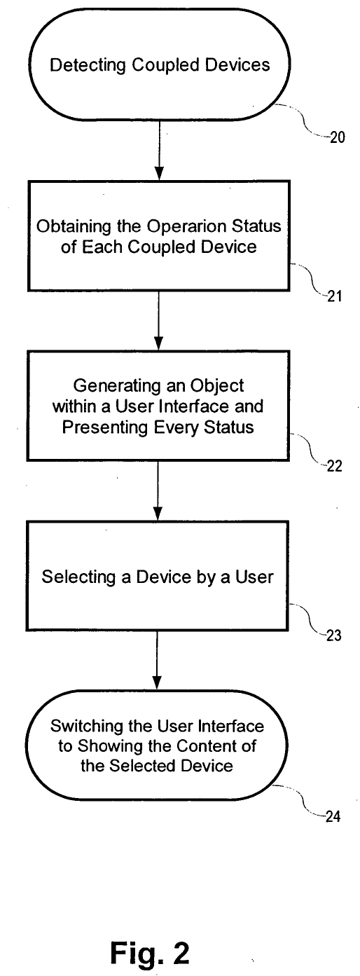

According to the preferred embodiment of the present invention, the computer-readable storage medium 10 is coupled to a media center or constitutes a portion of the media center. Referring to FIG. 2, the connection statuses of the media devices coupled to a media center are detected by the detecting module 101 in step 20. The media devices include a CD-RW drive, a DVD-RW drive, a DVD+RW drive, a Blu-ray drive, a VCD/DVD player, a DVD recorder, a TV tuner, a MP3 player, a photo viewer, or any other media player. It should be appreciated that the aforementioned types of the media devices are merely enumerated to illustrate the preferred embodiment, not to limit the present invention. The present invention would encompass all possible kinds of media devices. Besides, the media devices could couple to the media center via any possible data-transferring cables or the wireless transmission. In one embodiment of the present invention, certain media devices may be coupled to the media center via the network or Internet. Furthermore, the media center may be a computer or an apparatus with capability of controlling plural media devices synchronously. Controlling multiple media devices synchronously implies that the instant operation status of each media device is monitored and the operation of each media device is manipulated.

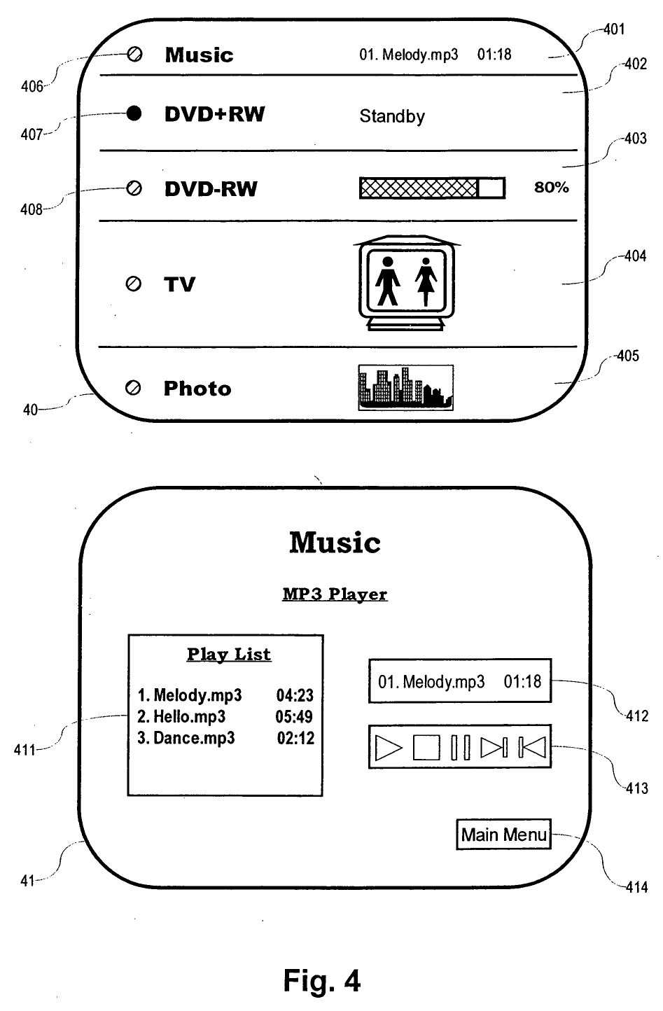

Therefore, in order to control these media devices synchronously, the operation statuses of them should be obtained by the operation status module 102 in step 21. Moreover, the operation statuses would be updated per predetermined period, preferably a few seconds, to keep instant information. With these instant operation statuses, the present invention then provides a user interface with an object therein by the interface module 103 in step 22. Such a user interface is able to present the operation status of each coupled media device. In one embodiment of the present invention, the method to indicate these operation statues includes presenting the operation status by distinguishable colors, a progress bar, or a preview window. For instance, as shown in section 402 in FIG. 4, when a coupled DVD+RW drive is idle or standby, its operation status may be presented as an indication such as a little circle (simulating an indicator light) colored green (407). As shown in section 403 in FIG. 4, when a coupled DVD-RW drive is running, i.e. writing data into or reading data from a DVD, its operation status may be presented as another indication, for example, a little circle colored red (408) as well as a progress bar showing the progress rate.

The interface module 103 is used not only for generating the object and the user interface, but also managing the showing of the generated object. That is, as one of the coupled media devices are selected by a user via an input apparatus or device in step 23, the showing of operation status would be switched to another showing that indicates the content of the selected device in step 24. The showing of the status and the content are illustrated in FIG. 4, and their details would be described in the subsequent description.

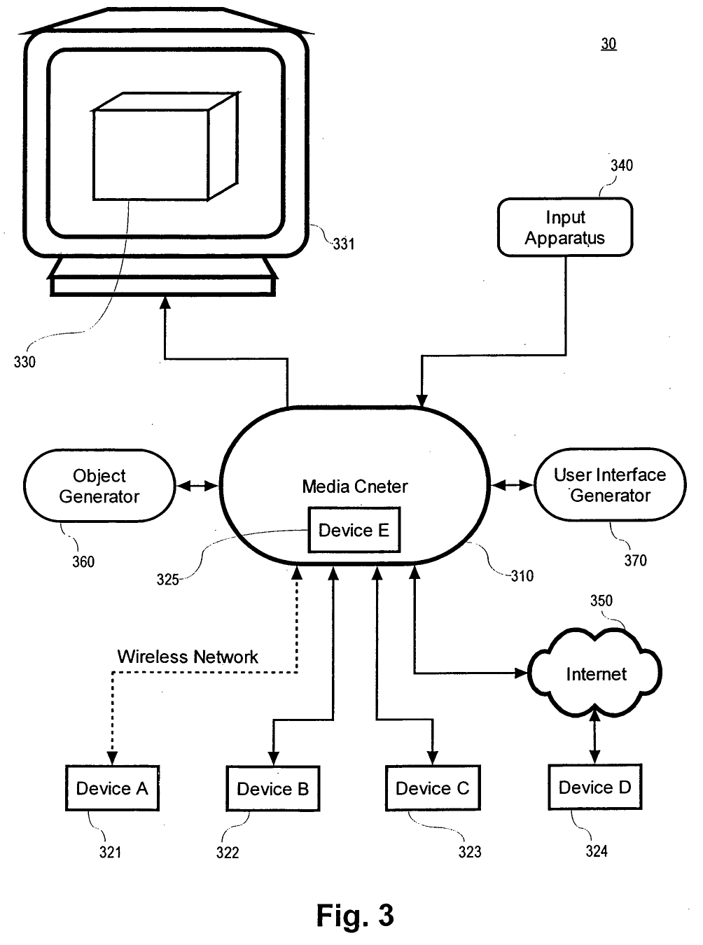

In accordance with another aspect of the present invention, a system for synchronously monitoring and controlling multiple media devices is disclosed. A preferred embodiment of the present invention is shown in FIG. 3. The system 30 comprises a media center 310, pluralities of media devices 321-325, a user interface generator 370, an object generator 360, a displayer 331 for displaying the user interface 330, and an input apparatus 340. The media devices 321-325 are individually coupled to the media center 310 by wired or wireless connection. As described above, the coupling way should be various, and four exemplary types are illustrated in FIG. 3. The device A (321) is coupled to the media center 310 via wireless network, the devices B and C (322 and 323) are coupled to the media center 310 via the data-transmission cables, and the device D (324) is coupled to the media center 310 through network such as Internet 350. In addition, the device E (325) constitutes a portion of the media center 310, for example, a DVD-RW drive (media device) installed in a computer (media center). It should be appreciated that the aforementioned coupling way is enumerated for illustration instead of limitation, and the present invention would encompass any possible way to couple the media device to the media center.

The displayer 331 is coupled to the media center 310 and used to display the user interface 330. The input apparatus is coupled to the media center 310 for selecting one of the coupled media devices 321-325 and controlling the operation mode of the selected device. The types of the displayer 331 may be any kinds of display device, such as the LCD, the PDP, the CRT monitor, or a projector, and the input apparatus may be any possible device with the capability of inputting instructions, such as a mouse, a keyboard, a keypad, a writing pad, a vocal control device or a remote controller. It should be appreciated that the aforementioned types of the displayer 331 and the input device 340 is enumerated merely for illustration instead of limitation.

In FIG. 3, the user interface generator 370 would generate the user interface, and the object generator 360 would generate a cube object 330 with six surfaces on the user interface. For example, the object may be created by the usage of certain software, such as the Flash® MX of Macromedia Inc. The two generators 360 and 370 are both coupled to the media center 310. The method for generating the object on the interface is well-known in the art, not the aspect of the present invention, and therefore, the detailed description is omitted. Besides the cube, the object 330 could preferably be any kind of three-dimensional polygon object with plural surfaces, such as a polyhedron, a ball, a pentahedron, a cube, a square pyramid, a prism, or an octahedron. In one embodiment of the present invention, one of the surfaces is used to present the statue of each coupled devices, and remaining surfaces are used to present the controlling panel or content of certain coupled device. The number of surfaces is varied with the demand of the user or the number of coupled media devices. In the preferred embodiment shown in FIG. 3, one surface of the cube object 330 is used as a main menu showing the operation status, as shown in surface 40 of FIG. 4. Remaining five surfaces of the cube 330 correspond to the coupled five media devices 321-325, respectively. The surface 41 of FIG. 4 represents one of the remaining surfaces for illustration.

Referring to FIG. 4, two surfaces (presentations) 40 and 41 of the user interface 330 are demonstrated. In the preferred embodiment shown in FIG. 4, the operation statuses of five coupled media devices could be monitored concurrently. The surface 40 is divided into five sections 401-405 and each section stands for one individual media device. As we can see, the section 401 shows the operation status of a music player which is playing a MP3 file named melody.mp3, and the indicator light of the section 401 would be red in order to show that this device (music player) is running. The indicator lights 406-408 may be a circle with distinguishable colors, and the pairing of the color and the situation is varied with the demand of the user or other possible considerations. With these indicator lights, the user could monitor all devices at once. Besides, the way to present the operation statuses does not limited to the indicator light or the progress bar, and the present invention may comprise other types of expression, such as the preview window. For instance, in section 403, the DVD-RW drive is writing data into a disc, and therefore the indicator light 408 would be red as well as the progress bar shows that 80% of data have been written. In section 404, the operation status of a coupled TV tuner is presented, and a preview window is shown in addition to the indicator light. Also, in section 405, the operation status of an image viewer is shown. The image viewer may be an application installed in a computer to demonstrate the image stored in some storage coupled to that computer or a device with the ability of capturing and keeping pictures in form of digital files, such as a digital camera, a cellular phone with camera, or a PDA with camera. The operation status of the image viewer is presented by a thumbnail of certain image as well as an indicator light, as shown in FIG. 4.

In one embodiment, the user interface's cube object 330 is a polyhedron with plural surfaces. One of theses surfaces is used as a main menu to present every operation status, and the main menu would switch to the surface showing the content and the control panel of a selected device as the selected device is chosen by the user. For example, the user may use a mouse to control the cursor to click on or apply a keyboard to designate the Music section 401 in surface 40. The main menu would be switched to the surface showing the content (411 and 412) and the control panel (413) of the music player. In the preferred embodiment of the present invention, the user interface 330 is a virtual rotatable three-dimensional object, such as a cube. When certain device is selected by using the input means, the rotatable cube 330 would switch the surface showing every operation status to the surface showing the content and the control panel of the selected device with the visual effect of rotating one surface to another. The visual effect of rotating is optional, and the present should encompass all possible kinds of visual effect.

In surface 41, the content and control panel of the music player is provided. In one embodiment of the present invention, the content includes the playlist 411 and the playing file 412, and the control panel 413 provides plural bottoms to control the operation of the player. If the selected device is a TV tuner, the content may be the TV program and the control panel may be use to switch channels and adjust the volume. The content and the control panel would be varied with the characteristics of each media device, and the aforementioned examples are cited merely for illustration instead of limitation. The surface 41 may also include a return bottom 414, and the user interface 330 would switch to main menu (surface 40) as the user applies the input means to “press” the return bottom 414.

With the present invention, the user could monitor all devices at once and control certain media device in a simple and convenient way. The concept of media center should base on not only linking all devices together, but also supervising these devices instantly and synchronously. Therefore, the present invention facilitates the management of multiple media devices, especially of a great amount of media devices.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A computer-readable storage medium having computer-executable instructions for synchronously controlling at least one device by performing the following, comprising:
detecting a connection status between a media center and said device;
obtaining an operation status of said device, wherein said operation status is updated in a predetermined period;
generating an object to present said operation status on a user interface, wherein said user interface is displayed on a displayer coupled to said media center; and
showing a controlling panel and content of a selected device on said object of said user interface, wherein said object includes at least two surfaces presenting at least two kinds of information.

2. The computer-readable storage medium as set forth in claim 1, wherein said operation status is presented by a distinguishable color, a progress bar, or a preview window.

3. The computer-readable storage medium as set forth in claim 1, wherein said object includes a virtual rotatable three-dimensional object which has a first surface showing said operation status and a second surface showing said controlling panel and said content of said selected device.

4. The computer-readable storage medium as set forth in claim 3, wherein said object is rotated when said selected device is selected.

5. The computer-readable storage medium as set forth in claim 3, wherein said virtual rotatable three-dimensional object includes a polyhedron or a ball.

6. The computer-readable storage medium as set forth in claim 5, wherein said polyhedron includes a pentahedron, a cube, a square pyramid, a prism, or an octahedron.

7. The computer-readable storage medium as set forth in claim 1, wherein said media center includes a computer or an apparatus with capability of controlling every said device.

8. The computer-readable storage medium as set forth in claim 1, wherein said device includes a CD-RW drive, a DVD-RW drive, a DVD+RW drive, a Blu-ray drive, a VCD/DVD player, a DVD recorder, a TV tuner, a MP3 player, a photo viewer, or any other media player.

9. The computer-readable storage medium as set forth in claim 1, wherein at least one of said devices are coupled to said media center through a network.

10. The computer-readable storage medium as set forth in claim 1, wherein said storage medium includes a CD, a DVD, a Blu-ray disc, a floppy disc, a hard disc, or memory.

11. A system for synchronously controlling at least one device, which comprises:
a media center for controlling said device coupled thereto;
a user interface generator coupled to said media center for generating a user interface;
an object generator coupled to said media center for generating an object on said user interface, wherein a first surface of said object presents an operation status of said device and said operation status is updated in a predetermined period;
a displayer coupled to said media center for showing said user interface; and
an input apparatus coupled to said media center for selecting a selected device, wherein a second surface of said object presents a control panel and content of said selected device as said selected device is designated via said input apparatus.

12. The system as set forth in claim 11, wherein said operation status is presented by a distinguishable color, a progress bar, or a preview window.

13. The system as set forth in claim 11, wherein said object is a virtual rotatable three-dimensional object.

14. The system as set forth in claim 13, wherein said object is rotated as said selected device is selected.

15. The system as set forth in claim 13, wherein said virtual rotatable three-dimensional object includes a polyhedron or a ball.

16. The system as set forth in claim 15, wherein said polyhedron includes a pentahedron, a cube, a square pyramid, a prism, or an octahedron.

17. The system as set forth in claim 11, wherein said media center includes a computer or an apparatus with capability of controlling every said device.

18. The system as set forth in claim 11, wherein said device includes a CD-RW drive, a DVD-RW drive, a DVD+RW drive, a Blu-ray drive, a VCD/DVD player, a DVD recorder, a TV tuner, a MP3 player, a photo viewer, or any other media player.

19. The system as set forth in claim 11, wherein said device is coupled to said media center through a network.

20. The system as set forth in claim 11, wherein said input apparatus includes a keyboard, a keypad, a mouse, a touch pad, a remote controller, or a writing pad.
